(19) United States
(12) Patent Application Publication
(10) Pub. No.: US 2006/0243318 A1
(43) Pub. Date: Nov. 2, 2006

(54) Solar Module For Generating Electrical Energy

(76) Inventors: Gunter Feldmeier, Lorsch (DE); Andreas Woeber, Kronau (DE); Heinz Scherer, Bensheim (DE)

Correspondence Address: BARLEY SNYDER, LLC, 1000 WESTLAKES DRIVE, SUITE 275, BERWYN, PA, 19312, US

(21) Appl. No.: 11/380,014

(22) Filed: Apr. 25, 2006

(30) Foreign Application Priority Data
Apr. 29, 2005 (DE) 102005020129.6

(51) Int. Cl. H02N 6/00

(52) U.S. Cl. 136/244

(57) ABSTRACT

The invention is directed to a solar module (1) having an electrical connecting system (3) which allows considerable flexibility with regard to the arrangement and interconnection of a plurality of solar modules (1) to form a solar module arrangement, for example on a flat surface.

The electrical connecting system (3) comprises at least one connector element (4) for external electrical connection of the solar module (1), wherein the connector element (4, 7, 8, 9) is connected with the layer arrangement (2) in a peripheral area (26) thereof via at least one contact element (5) projecting into the layer arrangement (2). The connector element (4, 7, 8, 9) comprises at least one mechanical connecting means, by means of which the connector element (4, 7, 8, 9) may be connected with a separately formed, further connector element (4, 7, 8, 9), which is in turn connected with the layer arrangement in the peripheral area via at least one contact element projecting into the layer arrangement (2).

### FIELD OF THE INVENTION

The present invention relates to a solar module for generating electrical energy and more particularly to an electrical connecting system for electrical interconnection of a solar cell within the solar module.

### BACKGROUND

A solar module for generating electrical energy typically comprises a layer arrangement comprising a planar front layer, for example a glass cover with low absorptivity, and a second planar layer, for example a rear glass cover. The individual solar cells, through a photovoltaic effect generate electrical energy and are arranged between these layers. They are interconnected with one another within the layer arrangement by conductors. In addition, the solar panel formed in this way is provided with a frame generally formed of aluminum, stainless steel or plastic material. In order to achieve higher voltages and currents, a plurality of solar cells are combined into solar modules by series and parallel connections. Solar modules of this type are generally assembled into solar module arrangements through mechanical and electrical connection, wherein the electrical connecting systems of the various solar modules for electrical interconnection of their respective solar cells are connected together by appropriate electrical connectors.

A solar module of the above-mentioned type is known from EP 0 798 787 A2, for example. This publication describes a sheet-form photovoltaic solar module, in particular for use as a facade or roof element. Within the solar module, connecting leads for electrical connection with adjacent further solar modules pass into the periphery. The connecting leads are attached to a connecting lug, which projects into the sheet's intermediate space and is embedded in the casting resin or the composite foil, and then led out of the sheet structure. The connecting lug is connected with an insulating sleeve extending outside the sheet structure, wherein the connecting elements thereof are connected in each case with a connecting lead laid through the insulating sleeve and may be interconnected with corresponding connecting elements of adjacent solar modules. The insulating sleeve rests on the edge of the sheet structure, wherein the connecting lug is connected rigidly with the hollow-cylindrical insulating sleeve, which preferably extends over the entire length of the module. An advantage of such a solar module is that it enables even construction personnel to install solar technology systems by simple assembly of modules using the connecting elements at the sleeve end. However, since the insulating sleeve is integrated partly into the sheet structure and connected rigidly with the connecting lug, a problem exists in that flexibility in the arrangement and interconnection of a plurality of solar modules is limited.

### SUMMARY

An object of the present invention is to provide a solar module of the above-mentioned type whose connecting system allows considerable flexibility with regard to the arrangement and interconnection of a plurality of solar modules to form a solar module arrangement, for example on a flat surface.

According to an embodiment of the present invention, a solar module of the above-mentioned type, has an electrical connecting system which comprises at least one connector element for external electrical connection of the solar module, wherein the connector element is connected with the layer arrangement in a peripheral area thereof via at least one contact element projecting into the layer arrangement. The connector element comprises at least one mechanical connecting means, by means of which the connector element may be connected with a separately formed, further connector element, which is in turn connected with the layer arrangement in the peripheral area via at least one contact element projecting into the layer arrangement.

According to a further embodiment of the present invention, the solar module of the above-mentioned type comprises an electrical connecting system which comprises at least one connector element formed outside the layer arrangement for external electrical connection of the solar module, said connector element being connected with the layer arrangement in a peripheral area thereof via at least one contact element projecting into the layer arrangement. At least a first part of the connector element extends along one edge of the layer arrangement and a second part of the connector element extends approximately orthogonally to the edge.

### BRIEF DESCRIPTION OF THE DRAWINGS

The invention is explained in more detail below with reference to the Figures of the drawings, which illustrate various embodiments of a solar module according to the invention wherein:

FIG. 1 is a representation of a solar module according to the invention in front and side sectional views and comprising a first embodiment of a connector element,

FIG. 2 is a perspective view of a portion of a solar module according to the invention comprising a further embodiment of a connector element,

FIG. 3 is a perspective view of a portion of a solar module according to the invention comprising a further embodiment of a connector element,

FIGS. 4-6 are perspective views showing respective representations of various variants of the construction and interconnection of a plurality of solar modules,

FIG. 7 is a perspective view of a further variant of the construction and interconnection of a plurality of solar modules, and

FIG. 8 is a partial perspective view of a variant additional to FIG. 7 of the construction and interconnection of a plurality of solar modules.

### DETAILED DESCRIPTION OF THE EMBODIMENTS

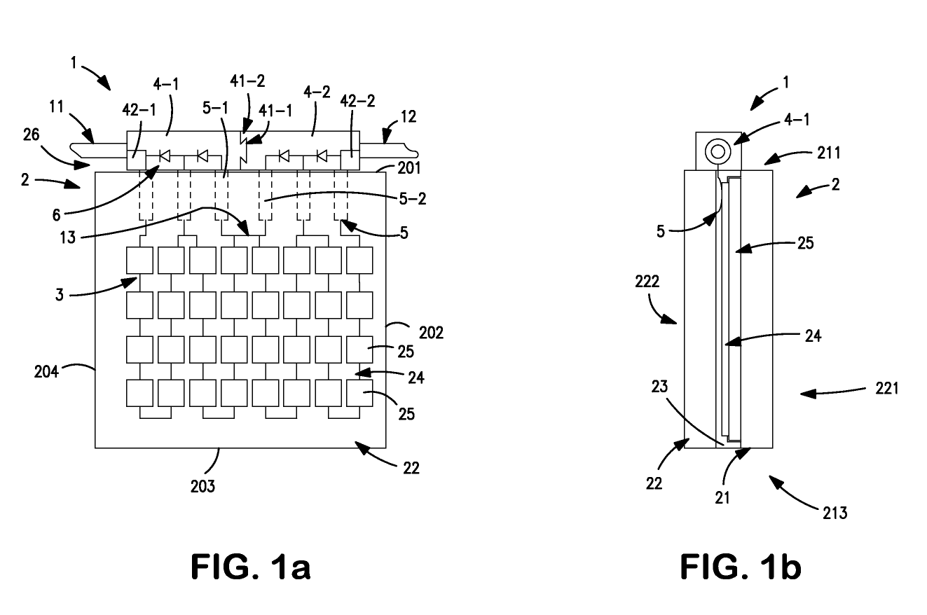

FIG. 1 shows a solar module according to the invention in front (FIG. 1a) and side (FIG. 1b) sectional view and comprising a first embodiment of a connector element, a so-called edge-connector. As is clear in particular from FIG. 1b, the solar module 1a comprises a layer arrangement 2, having a plurality of layers. In the present exemplary embodiment, a planar first layer 21 forms a front glass cover having low absorptivity, which serves to protect the solar cells within the layer arrangement 2. A second planar layer 22 is a glass sheet being an inner, back sheet of the solar module 1, wherein the layer 22 is arranged at a distance from the first layer 21, forming an interspace. On the inner side of the first layer 21 there are arranged one or more solar cells 25, which are in turn contacted on the inside by a foil 24, for example in the form of a copper foil. The solar cells 25 are embedded together with the foil 24 in potting compound 23, which substantially fills the rest of the interspace between the outer layer 21 and the inner layer 22. Instead of glass sheets, a flexible, for example film-type transparent material may be used for the layer arrangement, in order, for example, to be able to be conformed to three-dimensional surfaces, on which the solar modules are to be arranged.

As is clear in particular from FIG. 1a, the individual solar cells 25 are interconnected in series via an electrical connecting system 3, wherein the series connection of the solar cells 25 is formed at individual points by contact elements 5. Furthermore, the electrical connecting system 3 comprises two connector elements 4-1 and 4-2, also known as edge connectors, forming external electrical connection to the solar module 1, in particular in establishing an electrical connection between the solar module 1 and at least one external electrical device such as a load or in interconnection with a solar module. The connector elements 4-1 and 4-2 are connected with the layer arrangement 2 in a peripheral area 26 thereof in each case via a plurality of contact elements 5 projecting into the layer arrangement 2. The connector elements 4-1 and 4-2 are attached to an upper edge 201 of the solar module 1. The side edges of the solar module 1 are designated 202 and 204 as the right and left edges respectively. The solar module 1 is defined at the bottom by the lower edge 203. As is clear from FIG. 1b, the connector element 4-1 (as well as the connector element 4-2 not visible in FIG. 1b) is arranged on the upper side face 211 of the layer arrangement 2, wherein the contact elements 5 project into the inside of the layer arrangement 2. In this respect, after production the layer arrangement 2 and the contact element 5 are so arranged relative to one another that the foil 24 is contacted by the contact element 5. The front surface of the transparent layer 21 (in FIG. 1b the right-hand surface) forms a first major face 221 of the solar module, while the rear surface (in FIG. 1b the left-hand outer surface) of the inner layer 22 forms a second major surface 222 of the solar module 1. The major faces are the mutually facing larger surfaces of the sheet-form solar panel, wherein one of the surfaces with low absorptivity is oriented towards irradiated light and receives it and the other one is arranged opposite the former. Both of these layers serve in particular to protect the solar cells positioned on the inside.

As is further illustrated in FIG. 1a, the connector element 4-1 and the connector element 4-2 each contain a plurality of diodes 6, which, as respective bypass diodes, conduct a current past the associated group of solar cells 25 of the solar module if one or more solar cells of a respective group is/are not contributing or is/are contributing only to a limited degree to the generation of electrical energy. In this way, the module may continue to operate in partial shade and at correspondingly reduced power. According to the embodiment of FIG. 1, a plurality of contact elements 5 is provided, which project into the layer arrangement 2 and which are led out of the layer arrangement 2 for the purpose of contacting the connector elements 4-1 and 4-2. In each case one diode 6 provided in the connector element 4-1 and 4-2 is connected between the led-out contact elements 5.

According to the embodiment of FIG. 1, the connector element 4-1 comprises a mechanical connecting member in the form of a latching device 41-1, which is connected with a corresponding connecting member in the form of a latching device 41-2 of the further connector element 4-2. The latching device 41-1 is so designed in relation to the corresponding latching device 41-2 of the further connector element that the end of the further connector element 4-2 is moved towards the connector element 4-1 and connected with the connector element 4-1 in a final latching position. The connector elements 4-1, 4-2 latched together in this way are then connected with the layer arrangement 2 in the production process of the solar module 1. Other mechanical connecting arrangements are also feasible, such as for example screw fittings or the like, a latching device being particularly simple and quick to handle, without the need for additional accessories.

The connector elements 4-1 and 4-2 comprise respective electrical connection zones 42-1 and 42-2, which are so constructed that an electrical lead 11 or 12 respectively for connection with at least one external electrical device, which may for example also be a further separate solar module, is provided in this connection zone or may be connected thereto. For example, the leads 11 and 12 are injection-molded onto the respective connection zones 42-1 and 42-2, or may be connected in these zones via respective plug-in connectors. As is visible in the illustration of FIG. 1a, the electrical connection zones 42-1 and 42-2 of the connector elements 4-1 and 4-2 are arranged at an end remote from the respective latching device 41-1 or 41-2.

Since no diode is provided at the location of the mechanical latching devices 41-1, 41-2 or at the point of transition from one connector element to the other connector element, an electrical lead 13 is provided inside the connecting system 3 at an outer contact element 5-1, which is in contact with the connector element 4-1, in order to connect the outer contact element 5-1 with the corresponding outer contact element 5-2 of the further connector element 4-2. In this way, the two contact elements 5-1 and 5-2 are connected directly together, such that an electrical connection is established between the connector elements 4-1 and 4-2.

An arrangement of a solar module illustrated in FIG. 1 makes it possible to connect a solar panel in the form of the layer arrangement 2 simply and flexibly via a connector system for example with a further solar module. In the process, depending on the size and type of the solar panel a varying number of connector elements may be provided which are connected together and which also contain in particular an appropriate number of bypass diodes. This makes it possible to use this technology also for large solar panels wherein a suitable number of connector elements are used. Such a connector system has a high level of flexibility, since a plurality of solar modules may be taken into account with module dimensions and module arrangements which differ at virtually any desired point and have virtually any desired number of connector elements.

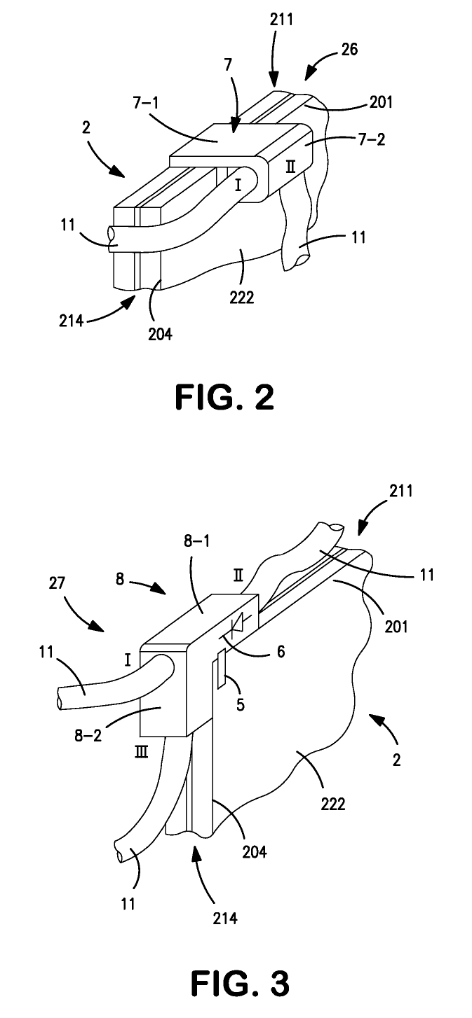

FIG. 2 shows a portion of a solar module with a further embodiment of a connector element 7 in the form of a so-called edge connector. The connector element 7 is formed outside the layer arrangement 2 and is contacted in the manner of the connector elements 4-1 and 4-2 according to FIG. 1 with the layer arrangement 2. The connector element 7 according to FIG. 2 is so configured that a first part 7-1 of the connector element extends along the edge 201 of the layer arrangement 2 and a second part 7-2 of the connector element extends in a direction which is approximately orthogonal to the edge 201. The first part 7-1 of the connector element 7 contacts the layer arrangement 2 via the side face 211 thereof, as is shown schematically in FIG. 2. The second part 7-2 of the connector element 7 projects into a major face 222, in the present case the rear surface of the layer 22 (FIG. 1b), of the layer arrangement 2. The second part 7-2 of the connector element 7 is so designed as a connecting zone that an electrical lead 11 for connection with at least one external electrical device may be provided, for example injection-molded, on the second part 7-2, or connected thereto, for example via a suitable plug connector.

FIG. 2 shows a number of variants for possible connection of the second part 7-2 of the connector element 7 in a single illustration, wherein the different variants are labeled I and II. According to variant I, contacting of the second part 7-2 is effected by the electrical lead 11 from a direction along the edge 201 of the layer arrangement 2 to which the first part 7-1 is attached. According to variant II, contacting of the second part 7-2 is effected by the electrical lead 11 from the direction of the opposite edge 203 (c.f. for example FIG. 1a) of the layer arrangement 2. Both variants make it possible to provide routing for the solar module at the rear surface of the module, such that for example an adjacent solar module may be brought comparatively close to the side face 211 or 214 for example from above or from the side. The connector element 7 may also additionally contain a diode as bypass diode, as already explained in more detail with reference to the exemplary embodiment of FIG. 1, wherein such a diode is not illustrated in FIG. 2 for reasons of clarity.

FIG. 3 is a further representation of a portion of a solar module according to the invention comprising a further embodiment of a connector element 8. The connector element 8 (so-called edge connector) according to FIG. 3 is likewise formed outside the layer arrangement 2 and, as is explained in more detail with reference to the exemplary embodiment of FIG. 1, is connected with the layer arrangement 2 in a peripheral area 26 via at least one contact element 5 projecting into the layer arrangement 2. The first part 8-1 of the connector element 8 extends along the edge 201 of the layer arrangement 2 and a second part 8-2 of the connector element 8 extends in a direction approximately orthogonal to the edge 201, namely along the edge 204. The first part 8-1 and the second part 8-2 of the connector element 8 are connected together approximately at right angles, wherein the connector element 8 is arranged in a corner area 27 of the layer arrangement 2. In this respect, the first and second parts 8-1, 8-2 of the connector element 8 are connected to the layer arrangement 2 at different edges 201, 204 thereof. As illustrated schematically by means of a diode 6, the connector element 8 contains a bypass diode, whose function has already been explained in more detail with reference to FIG. 1.

As in FIG. 2, the illustration of FIG. 3 also shows different variants for electrical connection of the connector element 8 in a single diagram. I denotes a variant in which the part 8-2 of the connector element is contacted by the electrical lead 11 from a direction directed towards a plane parallel to one of the side faces, in the present case the side face 214, of the layer arrangement 2. The lead 11 connects the solar module with at least one external electrical device, for example a further solar module or a load. Variant II shows a contacting option in which contacting of the part 8-1 is effected by the electrical lead 11 from a direction along the edge 201 of the layer arrangement 2 to which this part 8-1 is attached. Likewise, according to variant III contacting of the part 8-2 is effected by the electrical lead 11 from a direction along the edge 204 of the layer arrangement to which this part 8-2 is attached. In general, it should be mentioned in this context that all the outgoing leads or plug-in connector terminals do not have to be oriented parallel to an edge of the layer arrangement or at a right angle thereto. Instead, 45° angles or any other desired lead angles are feasible.

With a connector element 8 according to FIG. 3, a connector element is advantageously provided in the form of a corner component, which may be provided in space-saving manner at respective corners of the solar module, so as to provide flexible interconnection options and arrangement options for connector elements. The connector element 8 according to FIG. 3 is furthermore advantageously constructed as part of a frame of the solar module, so as to provide edge protection for the layer arrangement 2.

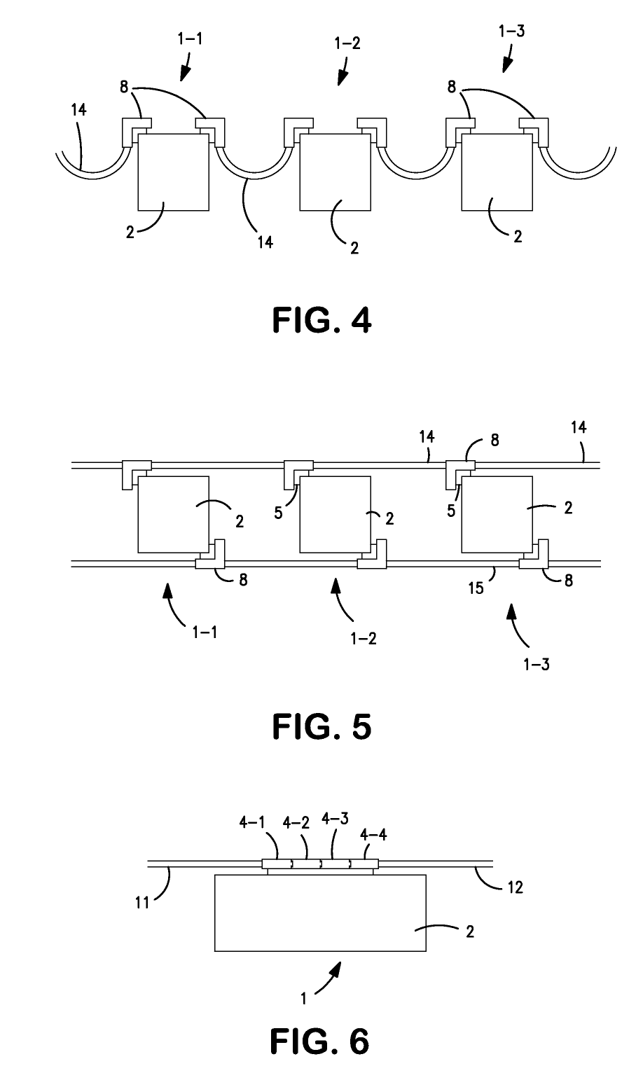

FIGS. 4-6 show respective representations of various variants for the construction and interconnection of a plurality of solar modules.

According to FIG. 4, a plurality of solar modules 1-1, 1-2 and 1-3 are interconnected in series, wherein an embodiment according to FIG. 3 is used as connector element. A respective corner connector is arranged at one of the top corners of the solar panel 2 and connected with an electrical lead 14.

FIG. 5 shows an interconnection variant according to which the solar modules 1-1 to 1-3 are connected in parallel. The top corner connectors 8 in the embodiment of FIG. 3 are connected together via a lead 14, whereas the bottom corner connectors 8 are connected together via a lead 15. The contact zones of the corner connectors 8, via which the corner connectors are connected with the respective panel 2, are shown shaded in the representations according to FIGS. 4 and 5. In these contact zones the connector elements are connected to the panel 2 via at least one respective contact element 5. As can easily be imagined from FIG. 5, a further arrangement similar to that of FIG. 5 may be brought from above or below to relatively close to the module arrangement according to FIG. 5, since the connector elements 8 of the two module arrangements do not touch one another. Instead, in the case of suitable routing a connector element 8 can be positioned relatively close to a further solar module brought close to it, so achieving overall a relatively tightly packed solar module arrangement.

FIG. 6 shows a representation of a solar module 1 in a variant arrangement which is based on the exemplary embodiment according to FIG. 1. According to the variant of FIG. 6, a plurality of connector elements 4-1 to 4-4 have been connected together by appropriate latching devices and contacted with the panel 2. The illustration according to FIG. 6 shows an embodiment in which an appropriate number of connector elements has been provided for a larger panel 2.

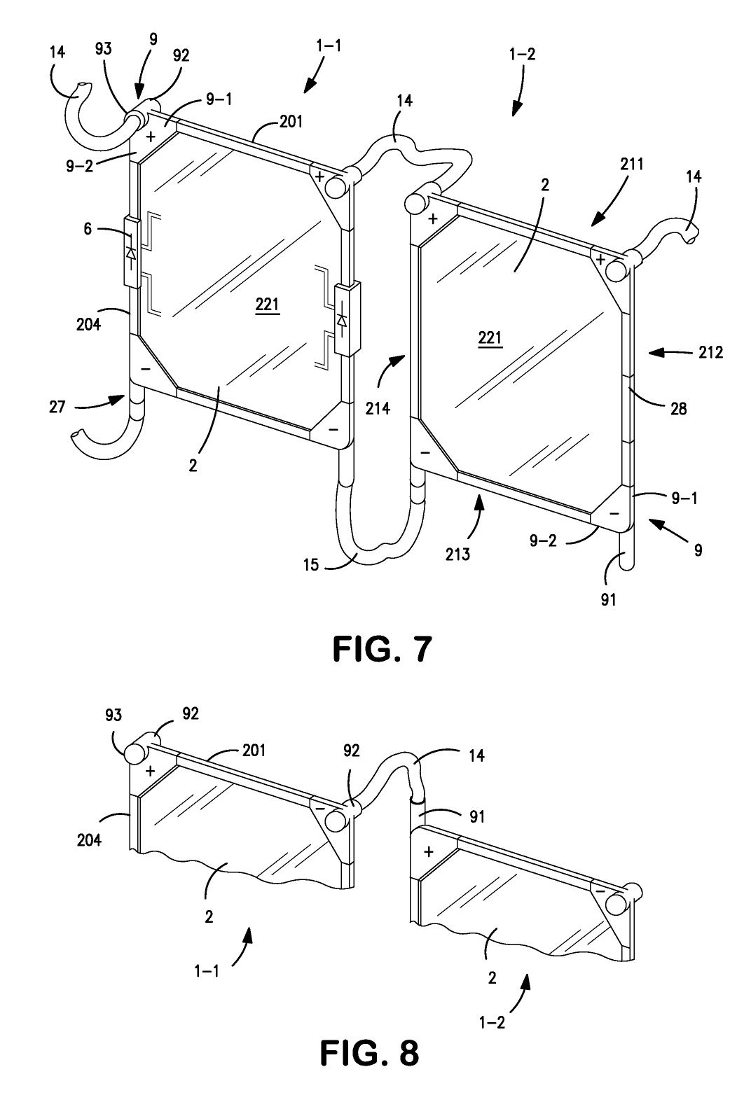

FIG. 7 is a representation of a further variant of the construction and interconnection of a plurality of solar modules according to the invention. According to FIG. 7, two solar modules 1-1 and 1-2 are connected together in parallel, wherein FIG. 7 shows in a single illustration a plurality of variants of connection options using appropriate connectors. In this respect, corner connectors 9 are provided, which are formed outside the layer arrangement 2 and are connected with the layer arrangement 2 in the manner as described above with reference to the other embodiments of a connector element. The connector elements 9 each comprise a first part 9-1 and a second part 9-2, these being connected together at the outer edges approximately at right angles, so forming a corner connector element. The upper row of the connector elements 9 is so constructed that contacting of a connector element by the electrical lead 14 is effected from a direction directed towards a plane parallel to one of the major faces 221 of the layer arrangement 2. In the present case, contacting of the connector element 9 is effected by the electrical lead 14 orthogonally to the major face 221 of the layer arrangement 2. In the lower row of connector elements 9, contacting thereof is effected by the electrical lead 15 from a direction directed towards a plane parallel to one of the side faces, in the present case the side face 213, of the layer arrangement 2. This means that the lower row of connector elements 9 is contacted from below via corner connectors 91 by the electrical lead 15, whilst the upper row of connector elements 9 is contacted from behind or from the front by the lead 14 via corner connectors 92 and 93.

The frame 28 of the respective solar module may be of plug-in or modular construction, as indicated in FIG. 7 by the segmented subdivision of the frame 28. The frame 28 may carry the current. Likewise, a frame connecting piece may be provided, with a diode 6 as bypass diode. The leads 14, 15 may be connected to the respective corner connectors by plugging in, or in a further variant are injection-molded onto the respective corner connector.

FIG. 8 shows a portion of a variant additional to FIG. 7 of the construction and interconnection of a plurality of solar modules. The solar modules 1-1 and 1-2 are connected together in series via different corner connector variants, as already explained with reference to FIG. 7.

As is clear from the illustrations of FIGS. 7 and 8, the respective connector elements 9 are designed as parts of the frame 28 of the respective solar module. The connector element 9, like the above-described embodiments of connector elements 4-1, 7 and 8, extends lengthwise by a distance which is small relative to the length of the layer arrangement 2 of the solar module. This makes it possible to provide only a small part of the peripheral area of the solar module with connector elements, such that neighboring solar modules may be tightly packed, as already described. It may also be advantageous to combine together the individual embodiments of connector elements, for example latching a connector element according to FIG. 1 to a corner connector according to FIG. 3. In this way, it is possible further to increase the flexibility of the connector system design.

With a solar module which is constructed in accordance with one or both of the stated aspects of the present invention, the following advantages may be achieved with regard to flexibility when arranging and interconnecting a plurality of such solar modules: a connector element for a solar module according to the invention may be prefabricated in a defined or in a plurality of defined embodiments and, depending on requirements, connected with the layer arrangement on production of the solar module. In this way, flexible positioning on a side face of the module or of the layer arrangement is made possible, such that a plurality of solar modules may be tightly packed together to form a solar module arrangement by positioning a connector element at a corresponding suitable point. Furthermore such a connector system provides the possibility of modular extension to a plurality of connector elements, to the effect that, depending on requirements and the size of the solar panel, appropriately shaped or an appropriate number of connector elements may be used. This makes it possible, in addition, to achieve different types of interconnection of a plurality of solar modules, for example series- and/or parallel connection of a plurality of solar cells or a plurality of solar modules, with a uniform connector system. Furthermore, connector elements of the solar module according to the invention are suitable for providing so-called bypass diodes in varying numbers, even for large solar panels, in one or more connector elements which are connected with a panel. Bypass diodes are needed so that the solar module can continue to operate at correspondingly reduced power in the case of partial shade or a partial defect. The bypass diode is connected in parallel with individual solar cells or a given solar cell arrangement and conducts the current generated past inoperative solar cells.

What is claimed is:

1. A solar module for generating electrical energy comprising:
a layer arrangement having a planar first layer, a planar second layer, which is arranged at a distance from the first layer, and at least one solar cell for generating electrical energy being disposed between the first and second layers;
an electrical connecting system for electrical interconnection of the solar cell, having at least one connector element for external electrical connection of the solar module, which element is connected with the layer arrangement in a peripheral area thereof via at least one contact element projecting into the layer arrangement;
wherein the connector element comprises at least one mechanical connecting member, for connecting the connector element with a further connector element, which is connected with the layer arrangement in the peripheral area via at least one contact element projecting into the layer arrangement.

2. A solar module according to claim 1, wherein the mechanical connecting member comprises a latching device, which may be connected with a corresponding latching device of the further connector element.

3. A solar module according to claim 1, wherein the mechanical connecting member is so arranged and constructed that the further connector element may be connected at the end with the connector element.

4. A solar module according to claim 1 wherein an electrical connection zone of the connector element is so constructed that an electrical lead for external electrical connection of the solar module is provided in this connection zone or may be connected thereto.

5. A solar module according to claim 4, wherein the electrical connection zone of the connector element is arranged at an end remote from the mechanical connecting member.

6. A solar module according to claim 1, wherein the connector element contains at least one diode, which conducts a current past at least one solar cell of the solar module if said cell is not contributing or is contributing only to a limited degree to the generation of electrical energy.

7. A solar module according to claim 1, having a plurality of contact elements projecting into the layer arrangement and extending outward therefrom; and one diode, contained in the connector element, being connected between the contact elements.

8. A solar module according to claim 7, wherein an electrical lead is provided on an outer contact element, which is in contact with the connector element, in order to connect the outer contact element with a corresponding outer contact element of the further connector element.

9. A solar module for generating electrical energy comprising:
a layer arrangement having a planar first layer, a planar second layer, which is arranged at a distance from the first layer, and at least one solar cell for generating electrical energy being arranged between the first and second layers;
an electrical connecting system for electrical interconnection of the solar cell having at least one connector element formed outside the layer arrangement for external electrical connection of the solar module, which connector element is connected with the layer arrangement in a peripheral area thereof via at least one contact element projecting into the layer arrangement;
wherein at least a first part of the connector element extends along one edge of the layer arrangement and a second part of the connector element extends in a direction approximately orthogonal to the edge.

10. A solar module according to claim 9, wherein the first part of the connector element contacts the layer arrangement via a side face thereof and the second part of the connector element projects into a major face of the layer arrangement, the second part having an electrical lead for external electrical connection of the solar module.

11. A solar module according to claim 10, wherein the second part of the connector element is constructed such that contacting of the second part is effected by the electrical lead from or contrary to the direction of an opposing edge of the layer arrangement.

12. A solar module according to claim 10, wherein the second part of the connector element is constructed such that contacting of the second part is effected by the electrical lead from a direction along the edge of the layer arrangement to which the first part is attached.

13. A solar module according to claim 9, wherein the first part and the second part of the connector element are connected to one another approximately at right angles, and the connector element is arranged in a corner area of the layer arrangement, wherein the first and second parts of the connector element are connected to the layer arrangement at different edges thereof.

14. A solar module according to claim 13, wherein at least one of the parts of the connector element has an electrical lead for external electrical connection of the solar module.

15. A solar module according to claim 14, wherein at least one of the parts of the connector element is contacted by the electrical lead from a direction along the edge of the layer arrangement to which the part is attached.

16. A solar module according to claim 15, wherein at least one of the parts of the connector element is contacted by the electrical lead from a direction directed towards a plane parallel to one of the side faces of the layer arrangement.

17. A solar module according to claim 14 wherein the connector element is contacted by the electrical lead from a direction directed towards a plane parallel to one of the major faces of the layer arrangement.

18. A solar module according to claim 9 wherein the connector element contains a diode, which conducts a current past at least one solar cell of the solar module if said cell is not contributing or is contributing only to a limited degree to the generation of electrical energy.

19. A solar module according to claim 9 wherein the connector element forms part of a frame of the solar module.

20. A solar module according claim 9 wherein the connector element extends lengthwise by a distance which is small relative to the length of the layer arrangement.
